(19) United States
(12) Patent Application Publication
(10) Pub. No.: US 2012/0052921 A1
(43) Pub. Date: Mar. 1, 2012

(54) MOBILE TERMINAL AND MULTI-TOUCH BASED METHOD FOR CONTROLLING LIST DATA OUTPUT FOR THE SAME

(75) Inventors: Wan Soo LIM, Gyeonggi-do (KR); Su Jung YOUN, Gyeonggi-do (KR); Kyoung Ae LIM, Seoul (KR); Sang Ki LEE, Seoul (KR); Su Mi SHIM, Gyeonggi-do (KR)

(73) Assignee: SAMSUNG ELECTRONICS CO., LTD., Gyeonggi-Do (KR)

(21) Appl. No.: 13/219,957

(22) Filed: Aug. 29, 2011

(30) Foreign Application Priority Data
Aug. 30, 2010 (KR) 10-2010-0083985

(51) Int. Cl. H04W 88/02; G06F 3/041

(52) U.S. Cl. 455/566; 345/173

(57) ABSTRACT

A mobile terminal including a multi-touch based system method for controlling list data output and a method for the same. The mobile terminal is capable of controlling list data output and includes: a touchscreen for generating various multi-touch events. The mobile terminal further includes a storage unit for storing lists of data items that are outputted to the touchscreen. The mobile terminal further includes; a control unit for controlling a the display of list data that are composed of multiple items for an application program in response to a currently active user function, and that changes in response to the generation of a multi-touch event, arrangement of the list data on the touchscreen according to the type of the application program to output a new list output screen.

### CLAIM OF PRIORITY

This application claims the benefit under 35 U.S.C. §119(a) from a Korean patent application filed in the Korean Intellectual Property Office on Aug. 30, 2010 and assigned Serial No. 10-2010-0083985, of which the entire disclosure is hereby incorporated by reference in its entirety

### BACKGROUND OF THE INVENTION

1. Field of the Invention

The present invention generally relates to a mobile terminal and, more particularly, to a mobile terminal and a multi-touch based system for controlling list data output for the mobile terminal so as to change the display format of output data in a rapid and convenient manner according to a multi-touch gesture of the user.

2. Description of the Related Art

As a result of major advances in information, communications and semiconductor technologies, applications and uses for mobile phone technologies have advances at a dramatic pace. Mobile terminals have evolved beyond the traditional role of telephonic communications and embrace other functions related to video calls, electronic schedulers, and the Internet. Mobile terminals have to support these functions utilizing advanced forms of hardware and software tools. Mobile terminals need to be configured to execute diverse applications for these hardware tools.

Mobile terminals may need to output various data related to various application programs. In particular, mobile terminals today need to provide data outputs from storage units typically in the form of a list where the location of particular desired item on the list is accessible by entering a scroll input by the user to skip some displayed items on the list.

In addition, the data stored in the storage unit may be be formatted as an extremely lengthy list that is composed of many items. These items may include a phonebook data stored in the storage unit containing several hundreds or even several thousands of person-related items.

It therefore may prove highly inconvenient for a user to have to enter a large number of scroll inputs in order to locate a desired item in a large phonebook stored in the mobile terminal. Further, due to the need for portability, the display units may have size limitations so that only a small number of items may be displayed on the display unit at one time,

It is therefore desirable to develop a means and apparatus that enables effective handling of frequent occurrences of touch events or input signals for locating a desired item during data output of a mobile terminal.

### SUMMARY OF THE INVENTION

The present invention offers a novel solution for the aforementioned problems by providing a mobile terminal that includes a multi-touch based system for controlling list data output that can change the display format of output data in a rapid and convenient manner in response to a multi-touch gesture of the user.

The present invention also provides a method and an apparatus for a mobile terminal that includes a multi-touch based system for controlling list data output that enables convenient utilization of the mobile terminal by reducing the number of repetitive and laborious touch operations.

The present invention further provides a method and an apparatus for a mobile terminal including a multi-touch based system for controlling list data output for the mobile terminal that enables the user to rapidly locate a desired list item.

In addition, the present invention provides a method and an apparatus for a mobile terminal in which a user may easily and rapidly locate a desired list item on the mobile terminal display in a less laborious way and with a significantly reduced number of touch gestures.

A mobile terminal is capable of controlling list data output, The mobile terminal includes a touchscreen that can generate various multi-touch events; a storage unit for storing lists of data items to be output to the touchscreen; and a control unit for a manner in which list data is where the list data is composed of multiple items for an application program realizing a currently active user function, and changes in response to the generation of a multi-touch event. The arrangement of the list data on the touchscreen depends upon the type of the application program for outputting a new list output screen.

### BRIEF DESCRIPTION OF THE DRAWINGS

The above features and advantages of the present invention will be more apparent from the following detailed description in conjunction with the accompanying drawings, in which:

FIG. 1 is a block diagram of a mobile terminal according to an exemplary embodiment of the present invention;

FIG. 2 is a detailed block diagram of a control unit in the mobile terminal of FIG. 1;

FIG. 3 is a flowchart of a method for controlling list data output based on touch events according to another exemplary embodiment of the present invention;

FIG. 4 is screen representations illustrating a first embodiment of the method of FIG. 3;

FIG. 5 is screen representations illustrating a variant of the embodiment of FIG. 4;

FIG. 6 is screen representations illustrating a second embodiment of the method of FIG. 3; and

FIG. 7 is screen representations illustrating a third embodiment of the method of FIG. 3.

### DETAILED DESCRIPTION OF EXEMPLARY EMBODIMENTS

Hereinafter, exemplary embodiments of the present invention are described in detail with reference to the accompanying drawings.

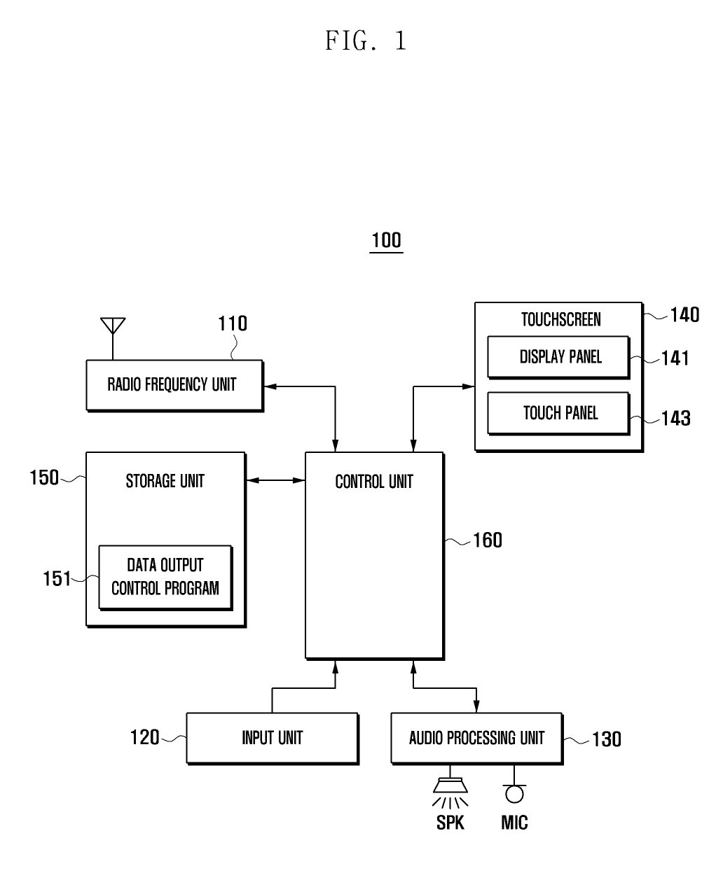

In one aspect of the invention, FIG. 1 is a block diagram of a mobile terminal 100 of an embodiment of the present invention wherein only components necessary for the description of a multi-touch based method for controlling list data output are illustrated.

Referring to FIG. 1, the mobile terminal 100 may include a radio frequency unit 110, an input unit 120, an audio processing unit 130, a touchscreen 140, a storage unit 150, and a control unit 160.

During the occurrence of a preset multi-touch event and while a user function is being activated, the mobile terminal 100 described above with the aforementioned configuration may change the display format of the currently output data in response to according to the multi-touch event. In particular, during the occurrence of a preset multi-touch event when data composed of multiple items is displayed, the mobile terminal 100 may display the data as a list of upper level items (an index list), as a list composed of both upper level items and lower level items of one of the upper level items related to the current item, or as a screen-optimized list of tightly packed items by removing a space without an assigned item. In such a case, the mobile terminal 100 changes the display format of the output data based upon the properties of the currently activated user function. Next, individual components of the mobile terminal 100 are described below in more detail.

The control unit 160 directs the radio frequency unit 110 to establish a communication channel for voice, video and data communication. Thus, the radio frequency unit 110 establishes a communication channel for a voice call, a data call and a video call with a mobile communication system. This is accomplished by the radio frequency unit 110 which may include a radio frequency transmitter to up-convert the frequency of a signal for transmission and amplification of the signal, and with a radio frequency receiver for low-noise amplifying a received signal and to down-convert the frequency of the received signal. In particular, the radio frequency unit 110 may be activated in response to a selection of one item in phonebook data stored in the storage unit 150. Upon connection to another mobile terminal or a web server, the radio frequency unit 110 may receive data in the form of a list of items. The multi-touch based list of data output control of the present invention may provide the user with the e received list of data items. This is accomplished by the mobile terminal 100 examining properties or attributes of the data that is received by the radio frequency unit 100. The mobile terminal 100 then applies the list data output control to this received data when a request is made to locate a particular item in the data by changing the display format of the output data according to a multi-touch event.

As seen in FIG. 1, the input unit 120 communicates with the control unit 160. The input unit 120 includes a plurality of alphanumeric and function keys for inputting alphanumeric information and for setting various functions. The function keys of the input unit 120 may include direction, side, and shortcut keys that are associated with specific functions. A key signal is generated by the input unit 120. The key signal corresponds to user manipulation for setting and controlling the operation of the mobile terminal 100 and the generated key signal is sent to the control unit 160. In particular, the input unit 120 may generate an input signal for selecting a user function, an input signal for selecting a desired item among data output on a display panel 141 after activation of the selected user function, and an input signal for changing the order of items in the output data, the display format of the output data and settings for the output data. The input unit 120 sends the generated input signal to the control unit 160.

The audio processing unit 130 communicates with the control unit 160 as shown in FIG. 1. The audio processing unit 130 includes a speaker SPK that outputs incoming and outgoing audio data during a video or voice call, and a microphone MIC for collecting an audio signal such as a voice signal during a video call. In particular, the audio processing unit 130 may output alert sounds or announcements in response to an input signal that is generated in order to change either the display format of the output list data or the display format. The audio processing unit 130 may also output a sound effect in response to an input signal to change the display format of the output list data.

The touchscreen 140 which communicates with the control unit 160 (FIG. 1) displays various menus, information that are inputted by the user, and information that is provided to the user. For example, the touchscreen 140 may output various screens that are related to utilization of the mobile terminal 100. These various screens include an idle screen, a menu screen, a message composition screen, a call handling screen, an ending screen and a boot screen. The touchscreen 140 may include a flat display panel 141 that may employ although not limited to liquid crystal display (LCD) devices or organic light emitting diodes (OLED), and a touch panel 143 placed above or below the display panel 141. In particular, data of a user function may be outputted onto the display panel 141 in a given display format. Subsequently, when a preset multi-touch event occurs on the touch panel 143, the display format of the output data on the display panel 141 may be changed to another according to the multi-touch event. A change in the display format of the output list data on the touchscreen 140 is described in more detail below with reference to the drawings.

The storage unit 150 may store programs employing user functions of the mobile terminal 100, screen data to be output to the touchscreen 140, and key maps, menu maps and information on the partial touch lock release zone for proper operation of the touchscreen 140. The key maps may correspond to various keyboard layouts including 3*4 and Qwerty layouts, and may include a control key map for controlling execution of an activated user function. The menu maps may include a menu map for controlling execution of an activated user function. The storage unit 150 may include a program region and a data region.

The program region may store a variety of software tools including but not limited to an operating system (OS) for booting and operating the mobile terminal 100, application programs for call-related functions, a web browser for accessing a web server on the Internet, application programs for playback of MP3 data, and application programs for viewing still images and moving images. In particular, the program region may store at least one of list application programs including but not limited to an index list output program for outputting data composed of indexes and lower level items of the indexes; a date application program like a calendar handling program for outputting data containing years; months and days; and a schedule application program like a schedule handling program for outputting pre-scheduled activities at a given date. The program region may store a data output control program 151.

The data output control program 151 includes a routine for outputting application data that is stored in the storage unit 150 to the touchscreen 140 in response to activation of an application program after turning the mobile terminal 100 on, and a routine for changing the display format of the current output data in response to a preset touch event occurring on the touchscreen 140. This output routine may include a subroutine for identifying the type of the application program, and a subroutine for outputting the application data composed of multiple items in the form of a list according to the application type, and a subroutine for outputting the multiple items in the form of a matrix according to the application type. The changing routine may include a subroutine that changes the display format from a list of items to a list that is composed of only upper level items of the current item according to an application type; a subroutine for changing the display format from a list of items to a list composed of both upper level items of the current item and lower level items of one of the upper level items that is related to the current item according to the application type; and a subroutine that changes the display format from a list of items to a screen-optimized list of tightly packed items by removing a space without an assigned item. The changing routine may further include a subroutine that recovers the previous list display format in response to a particular input signal or a touch event; and a subroutine for applying a zoom-in or a zoom-out operation to the screen in response to a given input signal or to a touch event.

The data region is an area that stores data generated during the use of the mobile terminal 100. The data region may store phonebook information; one or more icons associated with widgets, and various content. In particular, the data region may store various data that are required for execution of individual application programs. Application data may take a tree structure and elements or items from the application data may be output in the form of a list or grid. The data region may further store data to be output through the audio processing unit 130 as alert sounds, announcement sounds or as sound effects. The data region, if required may serve as a buffer to buffer touch events that are generated by the touchscreen 140.

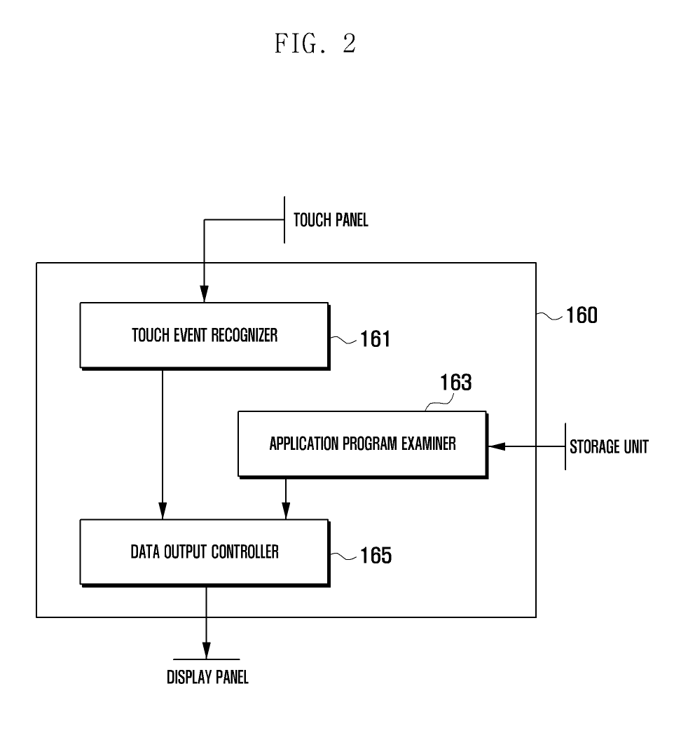

The control unit 160 controls the power supply to the components of the mobile terminal 100 for its initialization. In particular, the control unit 160 may perform signal processing and support various screen operations to control changes in the display format of the output list data responsive to multi-touch gestures. The control unit 160 may include a touch event recognizer 161; an application program examiner 163, and a data output controller 165 as illustrated in FIG. 2.

The touch event recognizer 161 provides for recognition of various touch events that are generated by the touch panel 143 of the touchscreen 140. The touch event recognizer 161 determines whether a preset multi-touch event is generated by the touch panel 143. Upon the generation of a preset multi-touch event, the touch event recognizer 161 forwards the multi-touch event to the data output controller 165. The touch event recognizer 161 may forward a touch event from the touch panel 143 to the data output controller 165, which may then in turn control a related user function on the basis of data that is selected by the touch event.

The application program examiner 163 identifies an active application program that will be receiving an input signal from the input unit 120 or a touch event from the touchscreen 140. The application program examiner 163 may send type information of a currently active application program to the data output controller 165.

The data output controller 165 may control an operation in order to change the display format of the current output data based upon the type information of a currently active application program from the application program examiner 163 and of a multi-touch event from the touch event recognizer 161. In particular, the data output controller 165 may control an operation to output a list of multiple items to the touchscreen 140 related to the type information of the active application program. When a specific multi-touch event such as a pinch gesture is generated, the data output controller 165 may control an operation to change the display format from a list of items to a list composed of only upper level items of the current item; to a list composed of both upper level items of the current item and lower level items of one of the upper level items related to the current item; or to a screen-optimized list of tightly packed items. Thus, with reference to a list of displayed items, upper level items may be presented as indexes or categories for the displayed items; lower level items of one of the upper level items may refer to the same level items as the displayed items; and a list of tightly packed items may be obtained by recursively removing an index without an assigned item or sub-index from a tree structured list of items. Operations for controlling changes in the display format are described in more detail below with reference to screen representations.

The mobile terminal 100 having the aforementioned configuration supports multi-touch based change of data display format and enables the user to locate a desired item among numerous data items in a rapid and convenient fashion.

The aforementioned description was of the configuration of the mobile terminal 100 and components thereof. The foregoing description describes a method and apparatus of the present invention for controlling list data output for the mobile terminal 100.

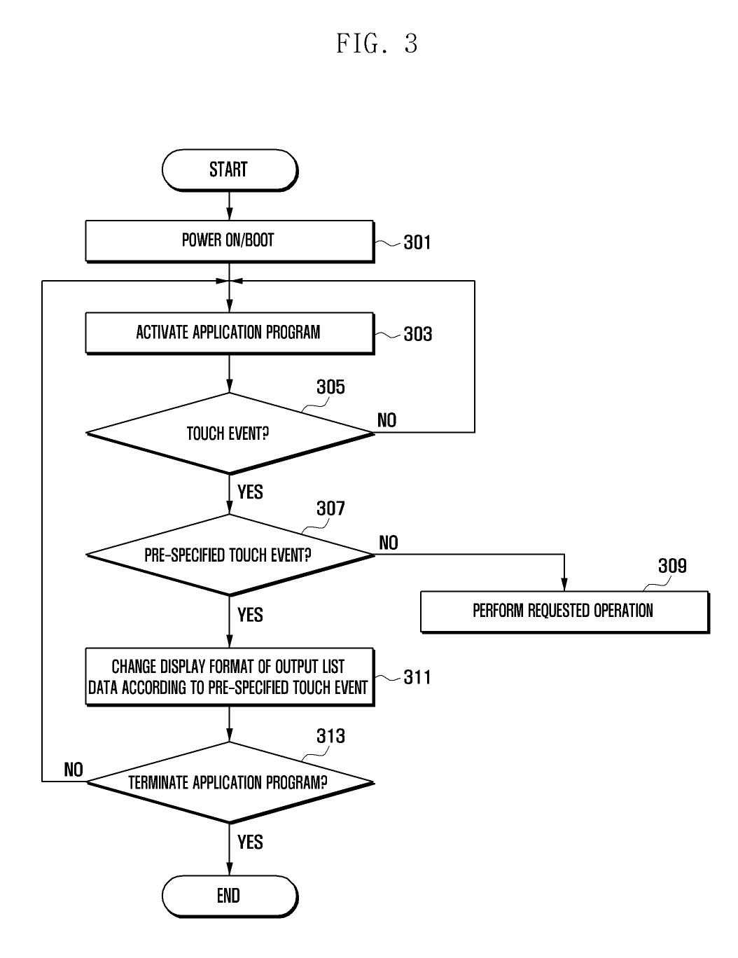

FIG. 3 is a flowchart of a method for controlling list data output based on touch events according to another embodiment of the present invention.

Referring to FIG. 3, the mobile terminal 100 is turned on and power is supplied (301). After a supply of power, the mobile terminal 100 initializes its components and executes a boot procedure.

After booting, the mobile terminal 100 activates a particular application program based upon information from a preset schedule and from an input signal received from the input unit 120 (303). For example, the mobile terminal 100 may output an idle screen to the display panel 141 according to preset schedule information. The mobile terminal 100 may output list data that is composed of multiple items to the display panel 141 based upon the preset schedule information and an input signal from the input unit 120. The application program is assumed to an output list data that is composed of multiple items describing changes in the display format in the foregoing illustration.

The mobile terminal 100 checks whether a touch event is generated (305). If no touch event has been generated, the mobile terminal 100 returns to step 303 and maintains the application program in an active state. In this step, when an input signal is generated by the input unit 120, the mobile terminal 100 may execute the application program according to the input signal.

When a touch event is generated, the mobile terminal 100 checks to see if the touch event is a pre-specified touch event (307). Thus, the mobile terminal 100 checks whether the touch event is a multi-touch event such as a pinch zoom-in gesture. When the touch event is not a multi-touch event, the mobile terminal 100 performs an operation that corresponds to the touch event (309). For example, when the touch event corresponds to an action for selecting an item associated with a user function, the mobile terminal 100 may highlight the selected item and execute the associated user function (for example, file playback, call placement, or item transmission). Execution of the user function may be related to the currently active application program.

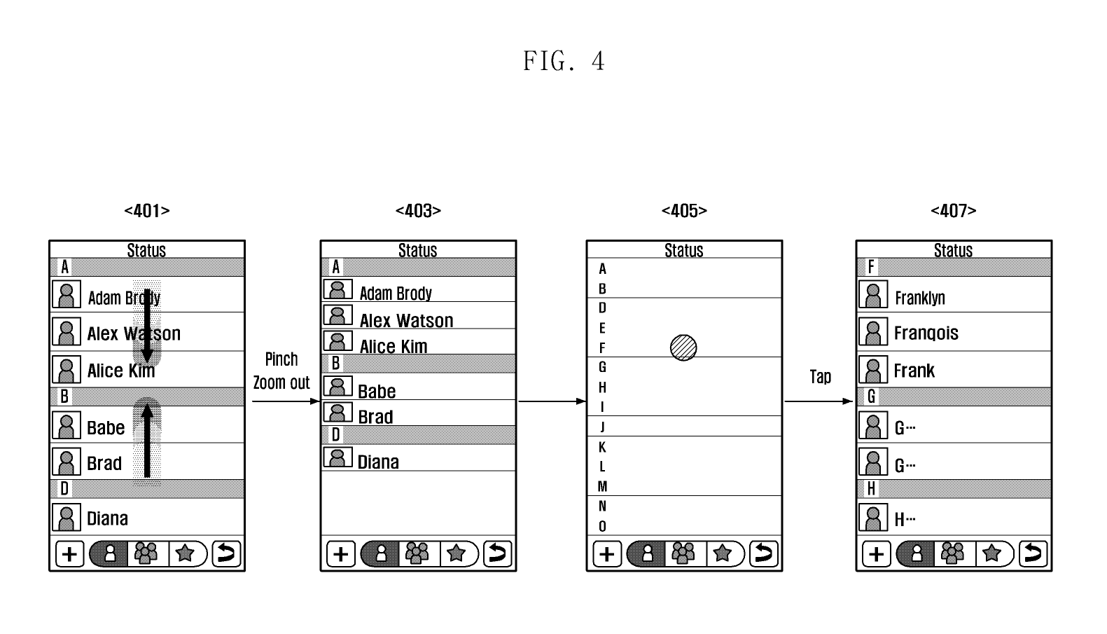

When the touch event is a pre-specified touch event, the mobile terminal 100 may change the display format of the output list data based upon the pre-specified touch event (311). Therefore, the mobile terminal 100 may transform the data list of displayed items into a list of upper level items; a list composed of both upper level items and lower level items of one of the upper level items related to the current item; or a screen-optimized list of tightly packed items. Changes in the display format of output list data are described below in more detail with reference to FIGS. 4 to 6.

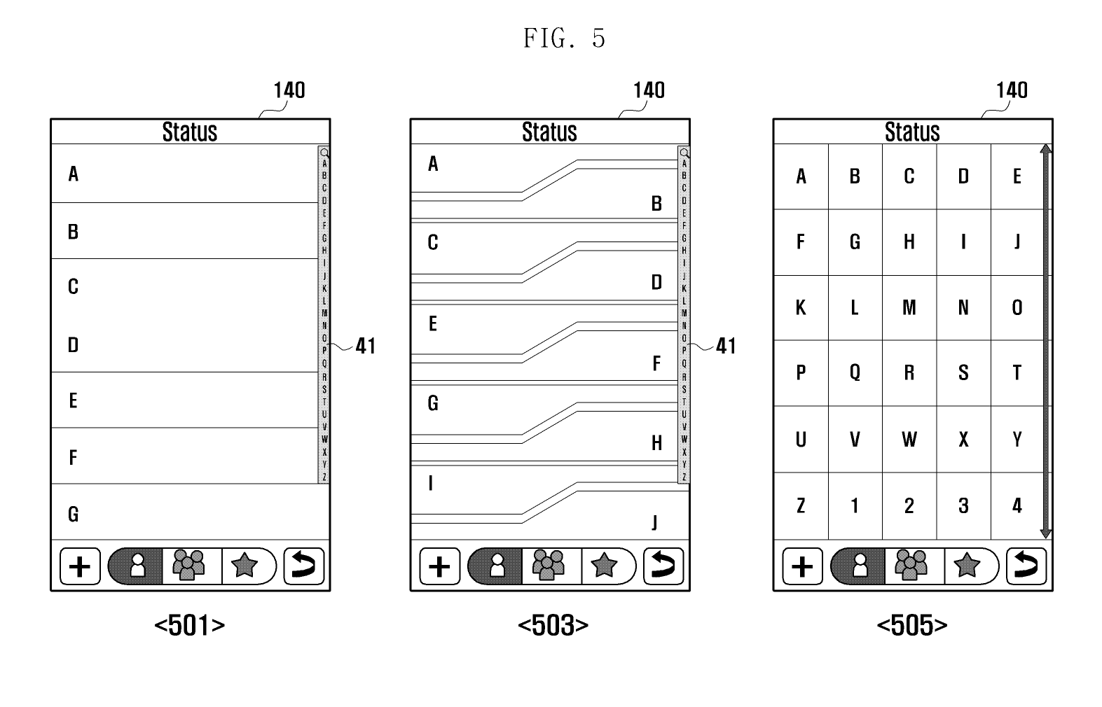

FIG. 4 illustrates screen representations showing a first embodiment of the method and apparatus for controlling list data output in accordance with the present invention. FIGS. 4 and 5 depict a change in the list data display format from a list of items to a list of upper level items only.

Referring to FIG. 4, the mobile terminal 100 may output list data composed of items that are classified by indexes to the touchscreen 140. In this instance, the user may generate an input signal for selecting and activating a menu item that is associated with a user function that may output list data composed of items classified by indexes. For example, the user may generate an input signal for activating a phonebook search function as a user function. Then, as illustrated in screen 401, the mobile terminal 100 may display a number of indexes (such as ‘A’, ‘B’ and ‘D’) and items belonging to the indexes (such as “Adam Brody”, “Alex Watson”, “Alice Kim”, “Babe”, “Brad” and “Diana”) so that an item belonging to an index is close to the index. The user may enter a multi-touch event by making a pinch zoom-in gesture while screen 401 is being displayed. A pinch zoom-in gesture may be done by touching the touchscreen with two fingers and bringing them closer together without losing contact

In response to the multi-touch event (pinch zoom-in gesture), the mobile terminal 100 performs screen transitions from screen 401 through screen 403 to screen 405. Here, screen 403 is an intermediate screen between screen 401 and screen 405. Hence, the mobile terminal 100 changes the display format from a list of indexes and items thereof as in screen 401 to a list of indexes as in screen 405 in response to a multi-touch event like a pinch zoom-in gesture. As in screen 405, the mobile terminal 100 displays a number of indexes that can be properly accommodated in one screen among many indexes of the phonebook data.

When the user touches an index (for example, ‘F’) in screen 405, the mobile terminal 100 may display a list of indexes and items thereof as in screen 407. Therefore, the selected index and items thereof are arranged at the top of the touchscreen 140, and subsequent indexes and items thereof are arranged next in sequenced order. For example, in screen 407, the selected index ‘F’ and items thereof are arranged at the topmost region, and index ‘G’ and items thereof are arranged next, and index ‘H’ and items thereof are arranged at the bottommost region.

In the aforementioned description, the mobile terminal 100 places the selected index at the top of the screen. It is understood however, that the present invention is not limited any particular such arrangement. For example, the mobile terminal 100 may place the selected index and items thereof from the bottom of the screen according to design or user selection.

In response to a multi-touch event like a pinch zoom-in gesture, the mobile terminal 100 may display a list of indexes in various forms as shown in FIG. 5 in addition to the form as in screen 405.

Referring to FIG. 5, when the user generates a multi-touch event like a pinch zoom-in gesture while screen 401 is being displayed, the mobile terminal 100 may display a list of indexes on the touchscreen 140, where the gap between indexes is wider than previously, as shown in screen 501. Here, the mobile terminal 100 may also output an auxiliary display region 41, in which all the indexes are displayed, at the right side of the touchscreen 140. The auxiliary display region 41 enables the user to easily locate a desired index. In a state in which a window like screen 501 is output, the user may easily select a desired one of the displayed indexes and easily locate a desired index through the auxiliary display region 41. The mobile terminal 100 may provide a scrolling capability to the auxiliary display region 41. When a touch event is generated in the auxiliary display region 41, the mobile terminal 100 may permit the user to directly access an index corresponding to the touch event. For example, when the user generates an input signal for selecting index ‘O’ among indexes displayed in the auxiliary display region 41, the mobile terminal 100 may display indexes around index ‘O’ on the touchscreen 140. Thus, in the output list of indexes, index ‘O’ may be one of the topmost entry, middle entry and bottommost entry. When the user touches a portion on the auxiliary display region 41 and moves up or down without losing contact (drag action), the mobile terminal 100 may scroll the output list of indexes in the corresponding direction on the touchscreen 140. Therefore, after scrolling, the mobile terminal 100 may display a list of indexes including the last index in the auxiliary display region 41 before scrolling.

When the user generates a multi-touch event while screen 401 is being displayed, the mobile terminal 100 may display a list of indexes on the touchscreen 140, where the indexes are arranged at the left and right sides of the screen, as in screen 503. More specifically, during display of a list of indexes, consecutive indexes may be arranged in a zigzag fashion on the screen and portions assigned to indexes may be wider than other portions without an assigned index to enable the user to easily select a desired index. For example, as shown in screen 503, index ‘A’ may be displayed at the top on the left of the screen and index ‘B’ may be displayed on the right below index ‘A’, and a double line may be drawn to separate the index ‘A’ region from the index ‘B’ region so that portions assigned to indexes ‘A’ and ‘B’ are wider than other portions. Indexes ‘C’ and ‘D’ (and other pair of consecutive indexes) may be arranged on the screen in the same way as indexes ‘A’ and ‘B’. As a result, the mobile terminal 100 may display an increased number of indexes in one screen. In addition, the mobile terminal 100 may provide an auxiliary display region 41 to enable the user to easily locate a desired index among many indexes.

When the user generates a multi-touch event while screen 401 is being displayed, the mobile terminal 100 may display a list of indexes in the form of a grid on the touchscreen 140 as in screen 505. More specifically, during display of a list of indexes, consecutive indexes may be arranged in individual cells of a grid on the screen. In order to accomplish this, the mobile terminal 100 may arrange grid cells on the touchscreen 140 and sequentially place indexes in the grid cells. Consequently, as in screen 505, the mobile terminal 100 may display many or all indexes in one screen without a separate auxiliary display region.

As described above, the list data output control method and apparatus of the present invention, enables the mobile terminal 100 to change the display format from a list of indexes and items thereof to a list of indexes in response to a multi-touch event.

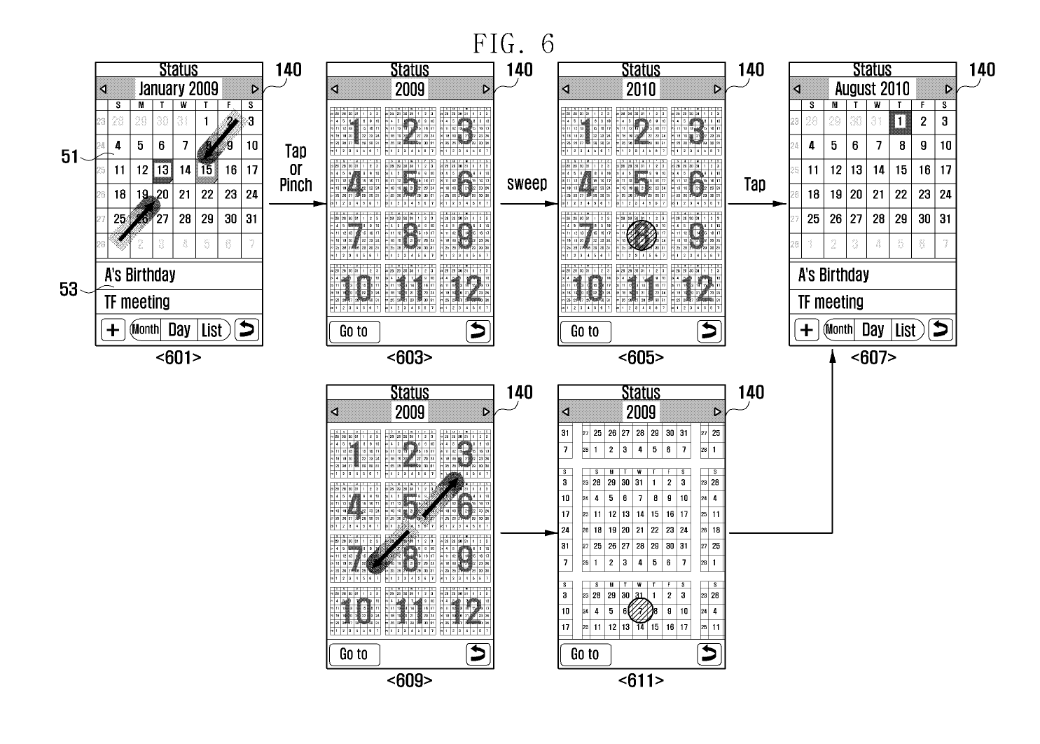

FIG. 6 shows screen representations illustrating a second embodiment of the method and apparatus of the present invention for controlling list data output. FIG. 6 depicts a change in the list data display format from a list of items to a list composed of both upper level items and lower level items of one of the upper level items related to the current item.

As shown in FIG. 6, the mobile terminal 100 may output the days of one month on the touchscreen 140. Therefore, when the user generates an input signal for selecting an item associated with a calendar function, the mobile terminal 100 may activate the calendar function to output a calendar region 51 (utilizing the current date as a reference) and a message region 53 as in screen 601. In the calendar region 51, information on, for example, birthdays or meetings may be assigned to individual days, and, for easy distinction, days with assigned information may have different colors or icons from other days without assigned information. The mobile terminal 100 may display assigned information in the message region 53. In particular, when the user indicates a day with assigned information, the mobile terminal 100 may display the information assigned to that day in the message region 53.

When the user generates a multi-touch event by way of non-limiting illustrative example with a pinch zoom-in gesture on the touchscreen 140 while the screen 601 is being displayed, the mobile terminal 100 may output upper level items of a currently displayed item on the touchscreen 140 as shown in screen 603. For example, in response to a multi-touch event such as a pinch zoom-in gesture while screen 603 having days as items (a list of items or days) is displayed, the mobile terminal 100 may display months as items (a list of upper level items or months) as shown in screen 603. Screen 603 depicts a state in which all months in year 2009 are displayed in one screen.

When the user generates a touch event by making a sweep gesture in the left direction on the screen 603, the mobile terminal 100 may output a calendar of the next year (i.e., year 2010) on the touchscreen 140 as in screen 605. Alternatively, if the user makes a sweep gesture in the right direction on screen 603, the mobile terminal 100 would output a calendar of the previous year (i.e., year 2008) on the touchscreen 140.

When the user generates a touch event for selecting a month (for example, August) of year 2010 on screen 605, the mobile terminal 100 may output days of the selected month as items on the touchscreen 140 as shown in screen 607. On the other hand, in response to a multi-touch event on the touchscreen 140 while screen 601 is being displayed, the mobile terminal 100 may output an upper level list (entire calendar of 2009) on the touchscreen 140. As shown in screen 609, when the user generates a multi-touch event such as but not limited to a pinch zoom-out gesture on the touchscreen 140, the mobile terminal 100 may zoom out the current screen thereby causing the region of a given month to become enlarged as shown in screen 611. Here, the region corresponding to the start points of the pinch zoom-out gesture may become the center of zooming. For example, when the pinch zoom-out gesture is started from a region at which May is displayed, the mobile terminal 100 may zoom out the entire screen so that the region of May is enlarged as the center of zooming. When the user generates a touch event for selecting a month (for example, August) of year 2010 on screen 611, the mobile terminal 100 may output a lower level item list (days of August) on the touchscreen 140 as in screen 607.

As described above, the list data output control method and apparatus of the present invention enables the mobile terminal 100 to change the display format from a list of items to a list of upper level items in response to a pinch zoom-in multi-touch event. Although the method and apparatus of the present invention is depicted as outputting upper level items in response to a pinch zoom-in multi-touch event, it may be modified to output the same in response to a pinch zoom-out multi-touch event.

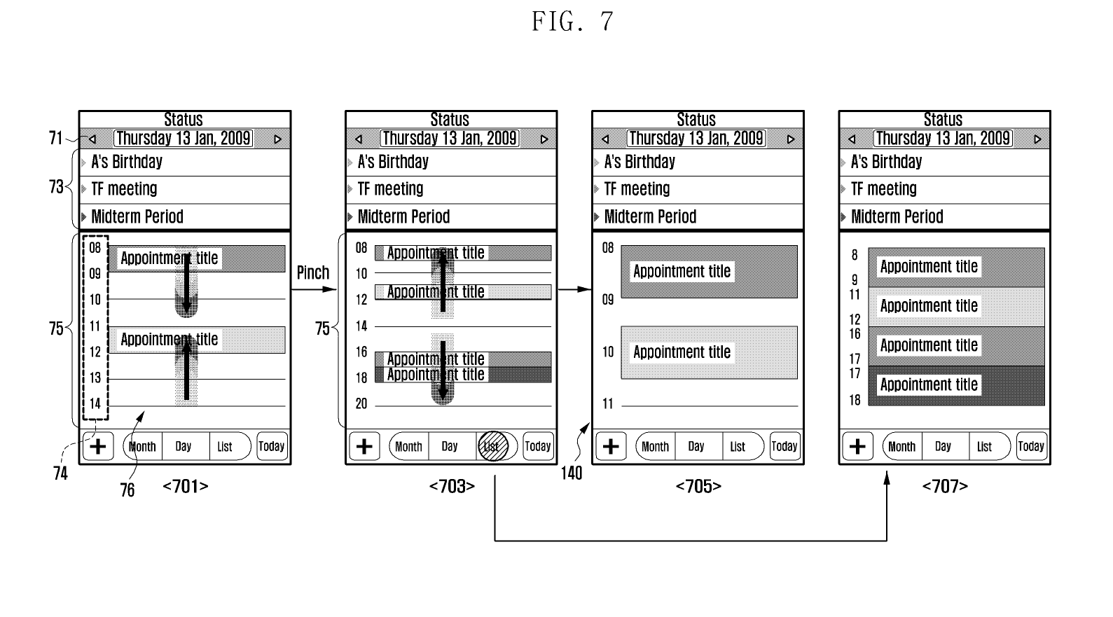

FIG. 7 depicts screen representations illustrating a third embodiment of the method and apparatus of the present invention for controlling list data output. FIG. 7 depicts a change in the list data display format from a list of items to a screen-optimized list of tightly packed items to display as many items as possible.

As shown in FIG. 7, the mobile terminal 100 may output a schedule setting screen having information concerning planned activities during regular intervals of time in one day as shown in screen 701. In the instant illustration, the user may generate an input signal for selecting a menu item associated with a scheduling function on the touchscreen 140. The schedule setting screen may include a date region 71 for outputting a date value; an activity title region 73 for locating a planned activity; and a scheduled activity region 75 for outputting planned activities for a given day. The scheduled activity region 75 may be divided into an hour region 74 for indicating hours in a day; and an activity display region 76 for displaying details of activities planned at specific times. For example, as shown in screen 701, the scheduled activity region 75 indicates that an activity is planned between 08:00 and 09:00 and another activity is planned between 11:00 and 12:00. The mobile terminal 100 may display details of planned activities at intervals of one hour in the scheduled activity region 75.

To examine all planned activities on a given day, the user may generate a multi-touch event like a pinch zoom-in gesture on the scheduled activity region 75 of screen 701. In response to the pinch zoom-in multi-touch event, the mobile terminal 100 may display planned activities for a wider range of hours during the day in the scheduled activity region 75 as shown in screen 703. Accordingly, the mobile terminal 100 may display time values at intervals of two hours from 08:00 and display planned activities with respect to time if present. Thus, essentially in order to accommodate as much schedule information as is possible in the scheduled activity region 75, the mobile terminal 100 may display planned activities in a reduced size.

When the user generates a multi-touch event like a pinch zoom-out gesture on the scheduled activity region 75 of screen 703, the mobile terminal 100 may display time values for wider intervals of time and display planned activities in an increased size as shown in screen 705. Thus, as the time interval has increased, the mobile terminal 100 may display a reduced number of planned activities in more detail. Put another way, in the scheduled activity region 75, planned activities may be output in a partial or coarse level (for example, titles only) in screen 701, and may be output in more detail in screen 705.

When the user generates a multi-touch event like a pinch zoom-in gesture on the scheduled activity region 75 of screen 701, the mobile terminal 100 may display planned activities as in screen 707. More specifically, the mobile terminal 100 may extract all planned activities for a given day and output the extracted planned activities with respect to time in the scheduled activity region 75. For example, when activities are planned at 08:00 to 09:00, 11:00 to 12:00, 16:00 to 17:00, and 17:00 to 18:00 on the given day, the mobile terminal 100 may output only these planned activities together with the corresponding time values in the scheduled activity region 75. As a result, by generating a specific multi-touch event on screen 701, the user may view a schedule setting screen containing only desired schedule information.

As described above, the list data output control method and apparatus of the present invention enables the mobile terminal 100 to generate a function related screen composed of only spaces with relevant information in response to a multi-touch event, and consequently the user may view a function related screen in a space-optimized way.

From the aforementioned description, the present invention provides a mobile terminal and multi-touch based system and method for controlling list data output for the mobile terminal that may change the display format of output list data based upon the type of the active application program and a multi-touch gesture of the user in order to output a function related screen enabling the user to easily locate a desired list item.

If necessary, the mobile terminal 100 may further include various components. Although not shown, the mobile terminal 100 may further include at least one of a short-range communication module for short-range communication; a data communication interface based on wired and wireless communication; an Internet communication module for Internet access; and a digital broadcast receiving module for playing digital broadcasts. With the digital convergence trend, it should be apparent to those skilled in the art that the mobile terminal 100 of the present invention may further include such as by way of non-limiting illustrative examples a unit comparable to the above-described units, and one unit of the mobile terminal 100 may be removed or replaced with another unit.

The mobile terminal 100 of the present invention may be a data processing device capable of outputting various items in the form of a list, and may be any information and communication appliance or multimedia appliance, such as by way of non-limiting illustrative examples a mobile communication terminal based on communication protocols supporting various communication systems; a portable multimedia player (PMP); a digital broadcast receiver, a personal digital assistant (PDA); a music player like an MP3 player, a portable game console; a smart phone, a notebook computer; or a handheld computer.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A mobile terminal capable of controlling list data output, comprising:
a touchscreen for generating various multi-touch events;
a storage unit storing lists of data items for outputting to the touchscreen; and
a control unit controlling a process of displaying list data composed of multiple items for an application program realizing a currently active user function, and changing, in response to generation of a multi-touch event, arrangement of the list data on the touchscreen according to the type of the application program to output a new list output screen.

2. The mobile terminal of claim 1, wherein said mobile terminal includes a radio frequency unit, an input unit, an audio processing unit, said touchscreen, said storage unit, and said control unit.

3. The mobile terminal of claim 1, wherein said control unit controls a power supply to components of said mobile terminal for its initialization.

4. The mobile terminal of claim 2, wherein said input unit communicates with said control unit, and said input unit includes a plurality of alphanumeric and function keys for inputting alphanumeric information and for setting various functions, and function keys of said input unit include direction, side, and shortcut keys that are associated with specific functions.

5. The mobile terminal of claim 2, wherein said audio processing unit communicates with said control unit and said audio processing unit includes a speaker that outputs incoming and outgoing audio data during a video or voice call, and a microphone MIC for collecting an audio signal such as a voice signal during a video call, said audio processing unit adapted to output alert sounds or announcements in response to an input signal that is generated in order to change either the display format of the output list data or the display format.

6. The mobile terminal of claim 1, wherein the control unit controls, based upon a generation of a multi-touch event and a type of the application program, an operation to output at least one of a list output screen containing only upper level items of the currently displayed items; a list output screen containing upper level items of the currently displayed items and lower level items of one of the upper level items; and a list output screen adapted to accommodate an increased number of displayable items through partial size adjustment, to the touchscreen.

7. The mobile terminal of claim 2, wherein said storage unit stores programs employing user functions of said mobile terminal, screen data to be output to said touchscreen, and key maps, menu maps and information on a partial touch lock release zone for proper operation of said touchscreen.

8. The mobile terminal of claim 6, wherein the adapted list output screen is configured by adjusting an image size of information to be displayed in a region so that all schedule information of a given day is displayable in the region, or by tightly packing schedule information through removal of a space without a planned activity so that the schedule information is displayable in one screen.

9. The mobile terminal of claim 6, wherein, when a touch event occurs in a state in which a list output screen containing only upper level items is displayed, said control unit controls an operation to output a new list output screen that contains the touched upper level item as the topmost item and further contains lower level items of the touched upper level item and lower level items of subsequent upper level items of the touched upper level item.

10. The mobile terminal of claim 1, wherein said multi-touch event corresponds to one of a pinch zoom-in gesture and a pinch zoom-out gesture.

11. The mobile terminal of claim 1, wherein the user function comprises one of a function for outputting data composed of indexes and items belonging to the indexes; a function for outputting data related to years, months and days; and a function for outputting information on planned activities for a given day.

12. The mobile terminal of claim 11, wherein said the control unit controls an operation for outputting a yearly calendar screen containing the month associated with the multi-touch event to the touchscreen when a multi-touch event is generated in a state in which a calendar screen is displayed responsive to activation of an application program outputting data related to years, months and days.

13. A method for controlling list data output for a mobile terminal, the steps comprising:
outputting a list output screen, said list output containing linked items that are correlated to activation of a user function;
generating a multi-touch event when said list output screen is displayed; and
controlling list data output by changing an arrangement of said output list data dependent based upon a type of the user function and of the multi-touch event in order to compose a new list output screen.

14. The method of claim 13, wherein said controlling list data output step further comprises outputting based upon the generation of a multi-touch event and of the type of the user function, one of:
a list output screen containing only upper level items of the currently displayed items;
a list output screen containing upper level items of the currently displayed items and lower level items of one of the upper level items; and
a list output screen adapted to accommodate an increased number of displayable items through a partial size adjustment.

15. The method of claim 14, wherein outputting an adapted list output screen further comprises one of:
generating a new list output screen by adjusting an image size of information to be displayed in a region in order that all schedule information of a given day is displayable in the region; and
generating a new list output screen by tightly packing schedule information through a removal of a space without a planned activity so that said schedule information is displayable in one screen.

16. The method of claim 14, wherein the controlling list data output step wherein when a touch event occurs in a state in which a list output screen containing only upper level items is displayed, said controlling list output step generates a new list output screen containing the touched upper level item as the topmost item and further containing lower level items of the touched upper level item and lower level items of subsequent upper level items of the touched upper level item.

17. The method of claim 13, wherein said generating a multi-touch event step further comprises one of making a pinch zoom-in gesture and making a pinch zoom-out gesture.

18. The method of claim 13, wherein said outputting a list output screen containing linked items step further comprises one of:
outputting a list output screen according to activation of a user function that outputs data composed of indexes and items belonging to the indexes;
outputting a list output screen according to activation of a user function that outputs data related to years, months and days; and
outputting a list output screen according to activation of a user function that outputs information on planned activities for a given day.

19. The method of claim 18, wherein said outputting a list output screen containing linked items step further comprises outputting, when a multi-touch event is generated in a state in which a calendar screen is displayed responsive to activation of a user function that outputs data related to years, months and days, a yearly calendar screen containing the month associated with the multi-touch event.

20. The method of claim 18, wherein said outputting a list output screen containing linked items step comprises outputting, in response to generation of a multi-touch event in a state in which a list output screen is displayed according to activation of a user function that outputs data composed of indexes and items belonging to the indexes, a new list output screen containing indexes only, wherein the new list output screen is composed of a display region containing some indexes and an auxiliary display region containing all indexes or is composed of grid-like cells containing all indexes, and wherein the display region contains indexes alternately arranged at left and right edge portions thereof and a distinguishing line is drawn between a pair of left and right indexes.
